(19) United States
(12) Patent Application Publication
(10) Pub. No.: US 2015/0225076 A1
(43) Pub. Date: Aug. 13, 2015

(54) PRESSURE JET PROPULSION SYSTEM

(71) Applicant: PROENTERPRIZ, INC., Spring Lake, MI (US)

(72) Inventor: Phillip G. Lawrence, Spring Lake, MI (US)

(73) Assignee: PROENTERPRIZ, INC., Spring Lake, MI (US)

(21) Appl. No.: 14/295,219

(22) Filed: Jun. 3, 2014

Related U.S. Application Data
(60) Provisional application No. 61/830,489, filed on Jun. 3, 2013.

(51) Int. Cl. B64C 27/12; B64C 27/06; F01D 25/12; F01D 5/28

(52) U.S. Cl. CPC B64C 27/12; F01D 5/28; B64C 27/06; F01D 25/12

(57) ABSTRACT

The pressure jet propulsion disclosed herein generally includes an air compressor for generating a mass flow of compressed air and a mast mount assembly in fluid communication with the air compressor for receiving and channeling the mass flow of compressed air. A positioning system supports the mast mount assembly and is movable on-demand to relocate the mast mount assembly relative to a center of gravity in response to environmental changes. Furthermore, at least two blades are in fluid communication with the mass flow of compressed air from the movable mast mount assembly, which is discharged through an outlet at an angle relative to an axis of rotation to cause rotation of the blades.

### BACKGROUND OF THE INVENTION

The present invention generally relates to a pressure jet propulsion system for a helicopter or the like. More specifically, the present invention relates to a pressure jet propulsion system for a helicopter that includes rotor blades driven by compressed air that travels up a mast, into the rotor head, down the length of each blade and exits at the tip of the blade causing the rotor blades to rotate.

Conventional helicopter technology started in about the 1940's. At that time, two main technologies were being developed, one that included a rogue version of the pressure jet propulsion technology as has been improved upon herein, and the more conventional and well known designs that were developed around a piston driven engine and turbine engine with direct drive technology. Pressure jet propulsion technology back in the 1940's and 1950's did not reach the appeal of manufacturers due to the limited development of engine and compressor technologies and the undesirable weight of the components at the time. Although, over the years, many different prototype helicopters incorporating pressure jet propulsion technology have been successfully built and flown. Despite this, manufacturers have primarily diverted helicopter development toward more conventional types of engines, transmissions, tail-booms and rear rotors, as are well known and in use today.

In a conventional helicopter, the driving force that rotates the blades comes from a mechanical link to a transmission driven by an engine. When power is applied to the drive shaft of the main rotor system, counter-torque is developed, which causes the fuselage of the helicopter to rotate in the opposite direction. To counter this yaw movement of the fuselage, a rear rotor vertically mounted on a tail boom is required to direct the fuselage. Any time power is applied to the drive shaft of the main rotor system, such as in lift-offs, turns, ascending or descending maneuvers, corrective yaw control is always required via foot pedals that change the pitch of the rear rotor blades. This change in pitch requires power changes which again cause counter-torque. Thus, a pilot must always attend to this never ending corrective action when flying a helicopter.

Conventional helicopters also have a complex mechanical assembly of components that interconnect the main rotor with the tail rotor. More specifically, there is a main transmission for the main rotor, a reduction gearbox for the rear rotor, a clutching system to disengage the main rotor in the event of engine failure, couplings, drive shafts, and in some cases belts that connect all of these components together. These components are not only relatively heavy, but they require frequent and costly maintenance.

There exists, therefore, a significant need for a pressure jet propulsion system that includes fewer components than conventional helicopter technology, which corresponds to light weight and greater payload capacity, reduced manufacturing costs, including design, production and assembly; and, as a result, considerably less annual maintenance, and elimination of counter-torque, thereby making the helicopter easier to fly. The present invention fulfills these needs and provides further related advantages.

### SUMMARY OF THE INVENTION

In accordance with the disclosures made herein, one embodiment for a pressure jet propulsion system includes an air compressor for generating a mass flow of compressed air and a mast mount assembly in fluid communication with the air compressor for receiving and channeling the mass flow of compressed air. A positioning system supports the mast mount assembly and is movable on-demand to relocate the mast mount assembly relative to a center of gravity, which may be specific to a helicopter, for example, and based on the number and weight of the passenger(s), luggage weight distribution, and other payload distribution(s), such as fuel. At least two blades are in fluid communication with the mass flow of compressed air from the movable mast mount assembly and include respective outlets along the length thereof for discharging the mass flow of compressed air at an angle relative to an axis of rotation, thereby causing the blades to rotate. In a particularly preferred embodiment, the pressure jet propulsion system is for use with a helicopter that includes an engine-driven air compressor that delivers a high mass flow of compressed air through ducts formed in the mast mount assembly and blades.

The positioning system may include a rail system having a pair of inwardly extending linear rails that reciprocally engage a pair of linear bearings in a base of the mast mount assembly. Here, the linear bearings ride on the linear rails and preferably allow the positioning system to move in both longitudinal and lateral directions, and preferably at least accommodates fore-aft movement. A load sensor may monitor the center of gravity and provide feedback to a controller that adjusts the positioning system on-demand. In this respect, a mast servo drive operated by the controller may accordingly locate and relocate the mast mount assembly on the track system. The mast mount assembly preferably includes a partially flexible duct to permit such movement relative to the otherwise stationary compressor and frame.

In one embodiment, the air compressor may include an engine-driven air compressor that can generate a mass flow of compressed air in the range of 3,000 to 5,000 cubic feet per minute (cfm) and typically in a temperature range between 300 and 500 degrees Fahrenheit. At temperatures in this range, conventional de-icing procedures or the type normally used with helicopters during cold weather conditions can be simplified or eliminated altogether. It may be desirable to include a heat sink coupled in line with the mast mount assembly to dissipate heat generation therefrom. Here, a pair of airfoil links may at least partially rotatably surround the heat sink and have a geometry configured to direct air over the heat sink when the blades are rotating. A heat sink that includes a plurality of fins may increase the surface area dissipation of heat and increase cooling efficiency. When used in association with a helicopter, the pressure jet propulsion system may further include a tail rudder for deflecting exhaust gasses emitted by the air compressor to further control movement.

In another embodiment, the pressure jet propulsion system may include an air compressor for generating a mass flow of compressed air and a mast mount assembly in fluid communication with the air compressor for receiving and channeling the mass flow of compressed air. In this embodiment, a rotor hub fluidly couples with the mass flow of compressed air from the mast mount assembly and fluidly couples to at least two blades extending therefrom. The rotor hub is pivotable on-demand to upwardly or downwardly reposition the at least two blades. In this respect, movement of the rotor hub may advance the at least two blades upwardly or recede the at least two blades downwardly. An outlet along each of the at least two blades discharges the mass flow of compressed air at an angle relative to an axis of blade rotation to cause the blades to rotate.

More specifically, the rotor hub includes a hollow rotor head and a spindle, the spindle being fluidly coupled to a top portion of the mast mount assembly. The rotor head also includes an arcuate surface pivotable relative to a reciprocally concave surface of the spindle. An O-ring may sit in a groove in the concave surface of the spindle, thereby permitting the rotor head to pivot hermetically relative to the spindle. Furthermore, the rotor hub may include a coupler for rotatable mounting to an airfoil link and a pin for pivotal coupling to a mounting fixture. Moreover, this embodiment may include at least two blade grip spindles respectively coupling the rotor hub to the at least two blades. Additionally, at least two blade grip bearing housings may respectively rotatably mount relative to the at least two blade grip spindles, the at least two blade grip bearing housings including a heat sink cooled by airflow during blade rotation. The at least two blade grip spindles include a circular flared end coupled to the rotor hub and a flat generally rectangular end for respective nested reception with the at least two blades. A collective may couple to the rotor hub, for increasing and decreasing elevation of the blades.

In another embodiment disclosed herein, the pressure jet propulsion system may include an air compressor for generating a mass flow of compressed air and a mast mount assembly in fluid communication with the air compressor for receiving and channeling the mass flow of compressed air. In this embodiment, a swashplate assembly is mounted concentrically over a spherical ball section of a sleeve slidably mounted relative to the mast mount assembly. The swashplate assembly preferably includes an upright post pivotally coupled to a rotor head having at least two blades extending therefrom and in fluid communication with the mass flow of compressed air from the mast mount assembly. The upright post preferably includes a pair of upright posts pivotally coupled to a pivot arm extending from a blade grip bearing housing. As described above, an outlet along each of the at least two blades discharges the mass flow of compressed air at an angle relative to an axis of rotation, wherein angled discharging causes the at least two blades to rotate about the axis of rotation. Furthermore, a pair of airfoil links may couple with the swashplate assembly and the rotor head such that the airfoil links rotate with the rotor head about a heat sink. Preferably, the airfoil links include a geometry configured to direct air over the heat sink, which may include a series of cooling fins extending away from the mast mount assembly.

More specifically, the swashplate assembly may move globally about a center of the spherical ball section and modify the global horizontal position of the at least two blades relative to a zero plane to change the pitch of the at least two blades in a forward, rearward, leftward or rightward manner by way of global movement about the spherical ball section. Although, a linkage assembly may limit radial movement of the swashplate assembly relative to the sleeve, while providing limited sliding movement of the sleeve relative to the mast mount assembly. Additionally, the swashplate assembly further includes a three piece inner ring assembly that includes an upper inner ring and a two piece lower inner ring and a two piece outer ring assembly that includes an upper outer ring and a lower outer ring. The three piece inner ring assembly and the two piece outer ring assembly couple about a radial bearing such that the inner ring assembly is stationary and the outer ring assembly is free to rotate about the radial bearing.

In another embodiment disclosed herein, the pressure jet propulsion system may include an air compressor for generating a mass flow of compressed air and a mast mount assembly in fluid communication with the air compressor for receiving and channeling the mass flow of compressed air. In this embodiment, the pressure jet propulsion system includes at least two blades each having a hollow interior with a duct therein in fluid communication with the mass flow of compressed air from the mast mount assembly. Each of the ducts includes a pair of indexing flanges offsetting the duct from the hollow interior of each blade to form a thermal gap therebetween. The duct may include multiple inter-fitting duct sections assembled together by slip fit engagement. An outlet along each of the at least two blades discharges the mass flow of compressed air at an angle relative to an axis of rotation, wherein angled discharging causes the at least two blades to rotate about the axis of rotation. Preferably, the ducts include an outlet tip that includes a sweep duct tip or a dead head transition tip. The sweep duct tip preferably includes an L-shaped curve to discharge the mass flow of compressed air at a 90 degree angle relative to a longitudinal length of the blade.

Preferably, the longitudinal surfaces of the duct expand and contract about the indexing flanges and within the thermal gap in response to thermal changes. The pair of indexing flanges may include a fore and aft flange or a top and bottom rib. A pair of blade grip transition ducts may respectively couple the mass flow of compressed air from the mast mount assembly to each of the at least two blades. Rotational speed of each of the at least two blades is a function of the speed of mass flow of compressed air discharging from each of the outlets. In this respect, increasing the mass flow of compressed air out through each outlet increases rotational speed of the at least two blades, and decreasing the mass flow of compressed air out through each outlet decreases the rotational speed of the at least two blades. In a particularly preferred embodiment, the each of the least two blades are made from aluminum, titanium, or a composite material and the duct is made from stainless steel. Of course, the specific number of blades may vary.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view showing the front and right sides of a helicopter incorporating one embodiment of a pressure jet propulsion system as disclosed herein;

FIG. 2 is an enlarged perspective view of the pressure jet propulsion system, including a centrifugal compressor, a hollow mast assembly including a swashplate, and at least two hollow rotor blades;

FIG. 3 is a alternative perspective view of the helicopter of FIG. 1;

FIG. 4 is a rear and right side perspective view of the helicopter of FIGS. 1 and 3, further illustrating an exhaust system for the yaw control of the helicopter;

FIG. 5 is a partial cut-away schematic view of the helicopter of FIGS. 1 and 3-4, illustrating fore-aft movement of the mast assembly for trimming;

FIG. 6 is an enlarged perspective view of the mast coupled to the helicopter, and further illustrating both longitudinal and latitudinal mast movement;

FIG. 7 is an enlarged perspective view of a blade grip and rotor blade assembly;

FIG. 8 is an enlarged perspective view of a head for mounting onto an upper end of a mast assembly;

FIG. 9 is an enlarged perspective view of the mast assembly;

FIG. 10 is an enlarged perspective view of a trimmable mast mount assembly for mounting onto a lower end of the mast assembly;

FIG. 11 is an enlarged perspective view of an engine-driven centrifugal compressor;

FIG. 12 is an enlarged exploded perspective view illustrating assembly of the entire pressure jet propulsion system components for a helicopter, as disclosed herein;

FIG. 13 is another enlarged and partially exploded perspective view illustrating a mast post and a related bearing housing;

FIG. 14 is an enlarged and partially exploded perspective view illustrating the mast post for coupling with the trimmable mast mount assembly;

FIG. 15 is an enlarged and partially exploded perspective view of a blade grip spindle for coupling with a rotor head assembly;

FIG. 16 is an enlarged and partially exploded perspective view of a blade grip unit for coupling with a blade grip bearing housing;

FIG. 17 is an enlarged and partially exploded perspective view of the rotor blade for the helicopter for coupling with the blade grip unit;

FIG. 18 is an enlarged perspective view of an exemplary rotor blade ducting for the helicopter;

FIG. 19 is an enlarged perspective view of ablade grip transition duct including a flange and lower and upper ducting sections welded together;

FIG. 20 is an enlarged and partially exploded perspective view illustrating a blade tip duct having a rearwardly sweeping or curving duct shape terminating in a relatively narrow outlet duct port, in accordance with one preferred embodiment;

FIG. 21 is an enlarged and partially exploded perspective view showing a two-piece blade tip duct having a capped end with a rearwardly facing outlet duct port, in accordance with an alternative embodiment;

FIG. 22 is an enlarged perspective view illustrating a slip-fit arrangement between duct sections and the blade tip duct ends of FIG. 20 or 21 onto the radially outermost end of the blade duct, to accommodate expansion and contraction therebetween;

FIG. 23 is an enlarged perspective about the circle 23 in FIG. 22, further illustrating the slip-fit arrangement;

FIG. 24 is an enlarged perspective view showing the cross-sectional internal rotor blade construction in accordance with one preferred embodiment;

FIG. 25 is another enlarged perspective view showing the internal rotor blade construction in accordance with an alternative preferred embodiment;

FIG. 26 is an enlarged perspective view showing details of an externally finned blade grip bearing housing;

FIG. 27 is an enlarged perspective view showing details of the externally finned mast bearing housing;

FIG. 28 is an enlarged and partially exploded perspective view illustrating airfoil links attached to the mast bearing housing and for attachment to a swashplate unit;

FIG. 29 is an enlarged and partially exploded perspective view showing a dual blade head with blade flapping motion;

FIG. 30 is an enlarged and partially exploded perspective view showing the dual blade head of FIG. 29 in combination with a sealed attachment to an underlying mast or spindle;

FIG. 31 is an enlarged and partially exploded perspective view of a 5-blade rotor assembly for mounting at the upper end of the mast or spindle;

FIG. 32 is an enlarged and partially exploded cut-out perspective view of the 5-blade rotor assembly of FIG. 31, and showing the internal passages through the individual rotor blades;

FIG. 33 is an enlarged perspective view of the swashplate assembly shown generally in FIG. 9;

FIG. 34 is an exploded perspective view of the swashplate assembly of FIG. 33, further illustrating orientation of a pair of inner and outer ring assemblies relative to a radial bearing and a spherical ball section; and

FIG. 35 is a partial cut-away schematic view illustrating one type of conventional piston driven helicopter capable of being retrofit with the pressure jet propulsion system disclosed herein.

### DETAILED DESCRIPTION OF THE PREFERRED EMBODIMENTS

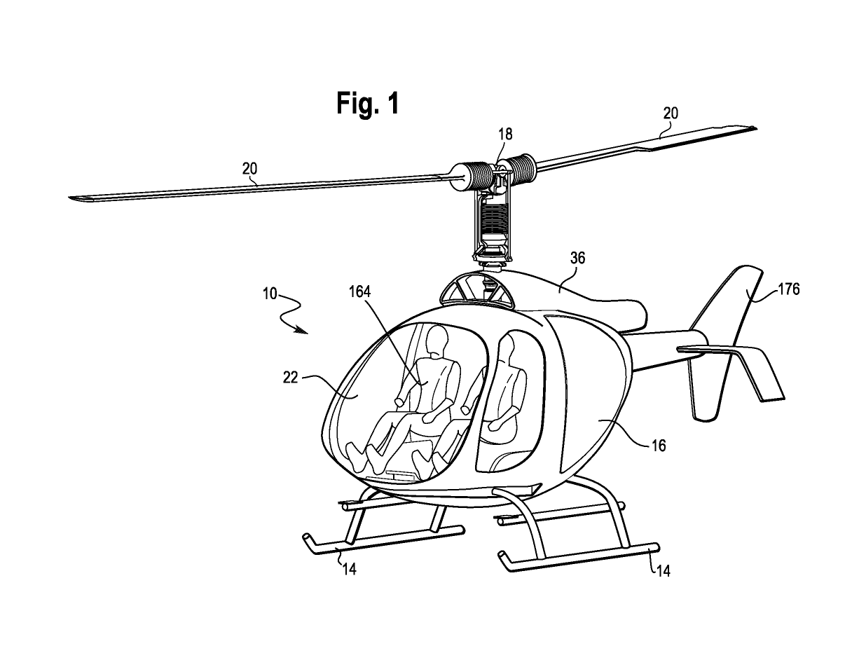

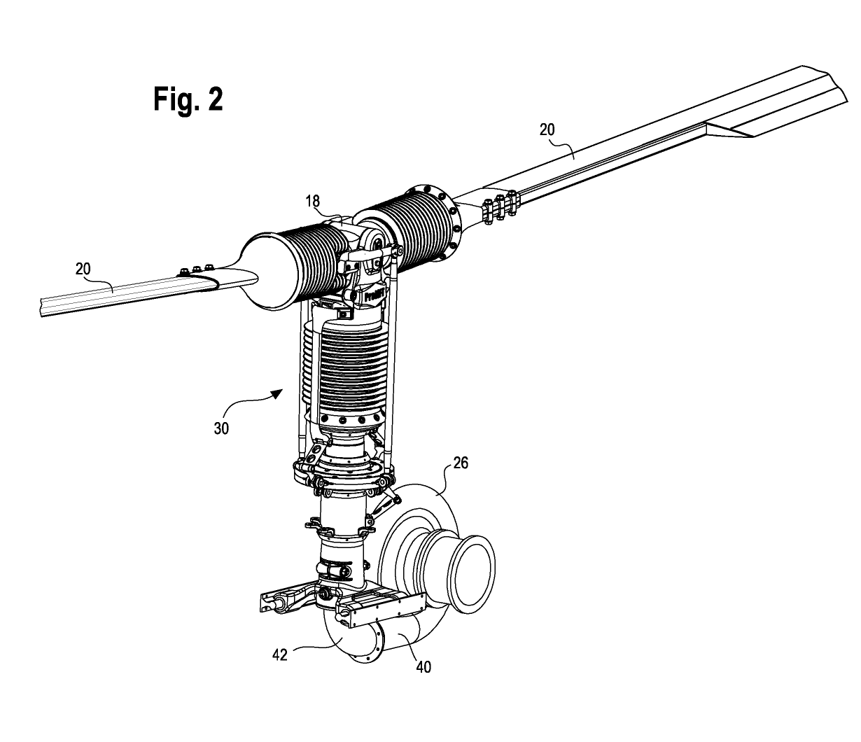

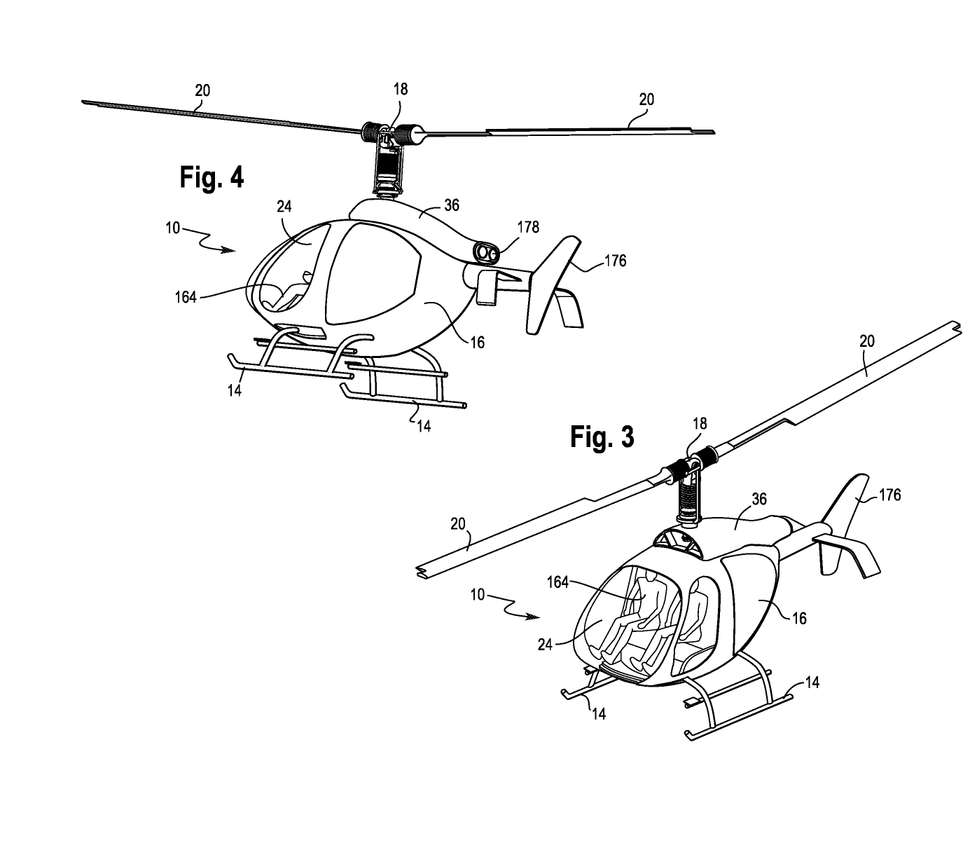

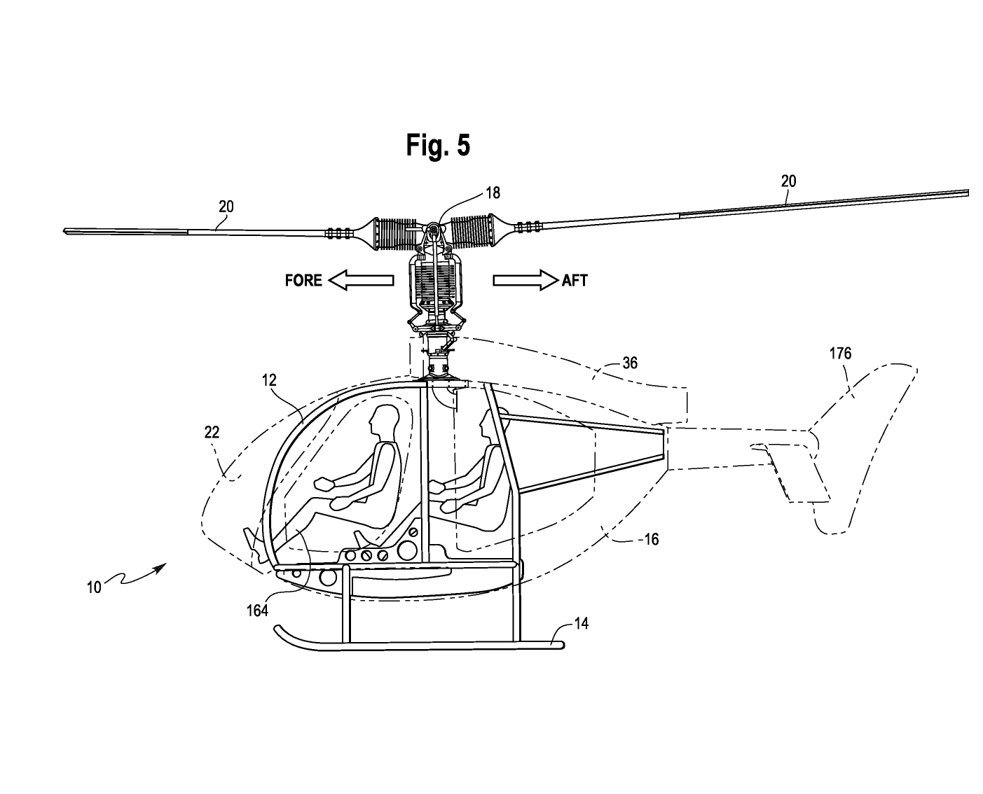

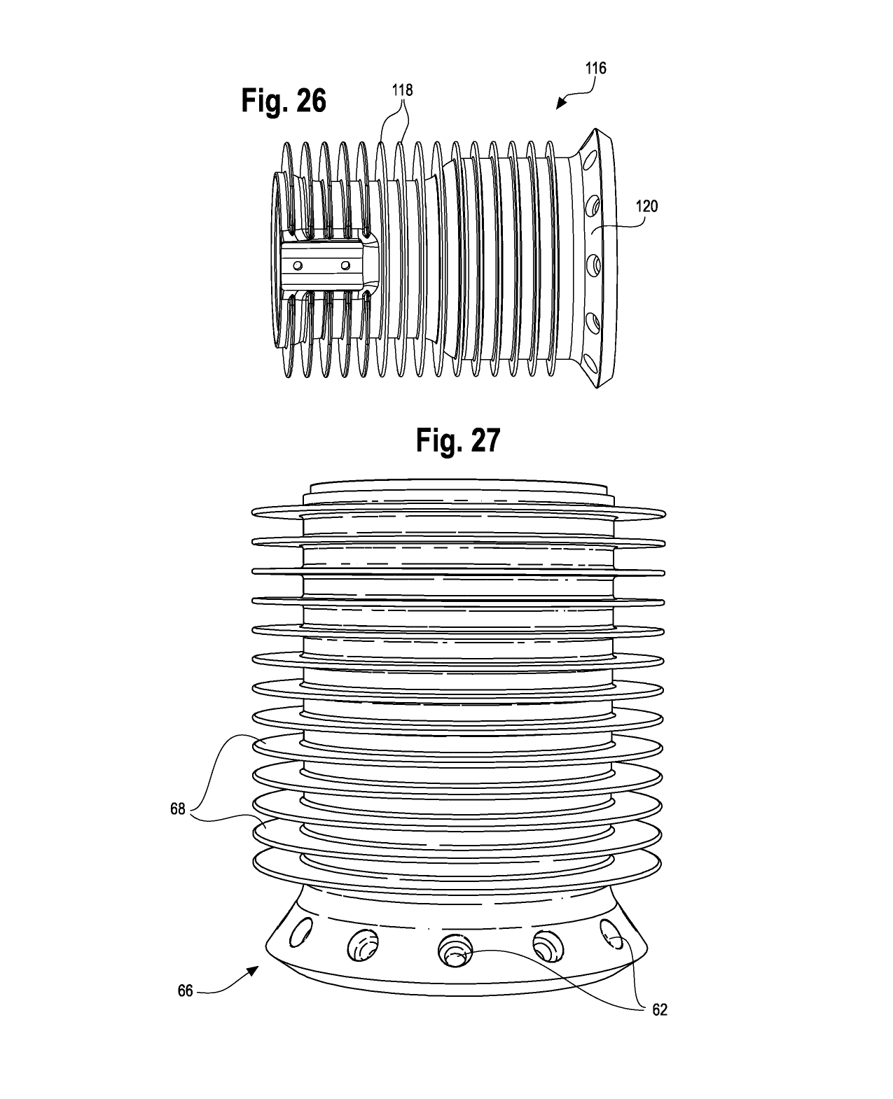

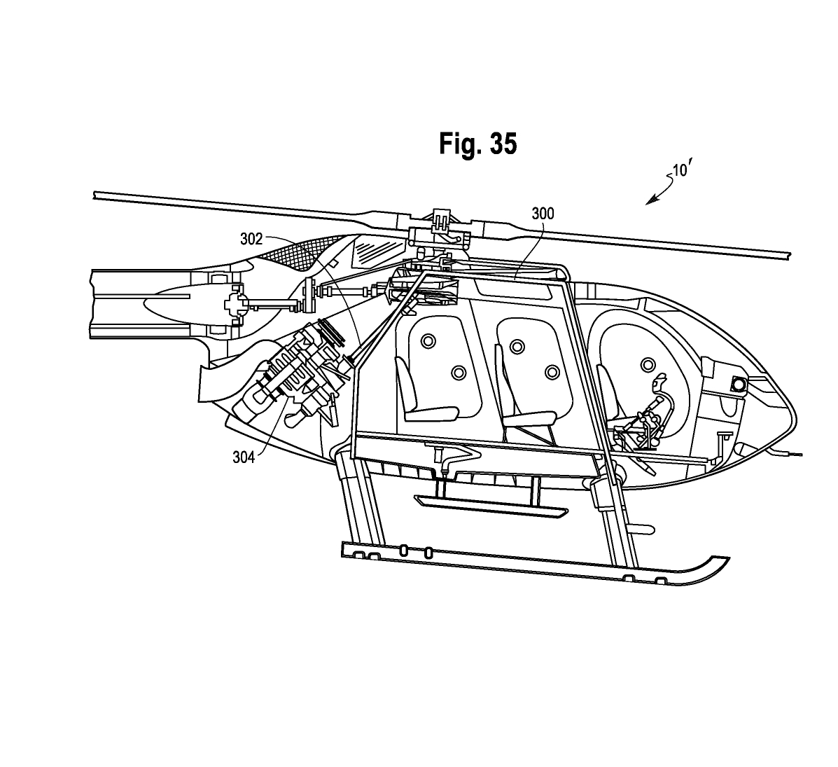

As shown in the drawings for purposes of illustration, the present invention for a pressure jet propulsion system is generally shown with respect to the embodiments in FIGS. 1-32. More specifically, the pressure jet propulsion system disclosed herein is shown generally as integrated into a helicopter 10 as shown in FIGS. 1 and 3-6. Although, persons of ordinary skill in the art will readily recognize that the pressure jet propulsion system may be incorporated into existing helicopter designs as a retrofit system and/or optional propulsion system, such as the helicopter 10′ shown in FIG. 35. The helicopter 10 can be as simple as the design shown in FIGS. 1 and 3-6, including a tubular frame 12 and skids 14, a molded fuselage 16, a cast Titanium rotor hub 18, at least a pair of fabricated blades 20, a simple wiring loop with readily available instruments, a Plexiglas windshield 22 and doors 24, a reciprocating piston engine or turbine engine, a centrifugal compressor 26 and related hardware. More specifically, the pressure jet propulsion system uses an air compressor 26 (FIGS. 2 and 11-12) to generate compressed air for flow through open ducts or duct passages leading from the compressor 26, through a mast mount assembly 28, up into a mast assembly 30, through a head assembly 32 and out through a plurality of ducted rotor blades 20 leading to exhaustion of the compressed air in a rearward direction from the tip end of each rotor blade 20. The mass flow rate of compressed air generated by the compressor 26 largely determines the rotational speed of the rotor hub 18 and speed that the rotor blades 20 rotate.

One main advantage of pressure jet propulsion technology over known conventional direct-drive helicopter propulsion technology that uses piston and or turbine-based engines is that pressure jet propulsion systems eliminate roughly two-thirds of the drive components (and accompanying weight) required to fly the helicopter 10. Such simplicity decreases the need for sophisticated and expensive components. In this respect, pressure jet propulsion systems do not require main transmissions, reduction gearboxes, clutching systems, couplers, shafts, booms or rear tail rotors. Eliminating these power-robbing and trouble-prone mechanical components, pressure jet propulsion systems of the type disclosed herein are able to achieve considerable savings on weight, thereby permitting a greater payload. Additionally, sophisticated maintenance and training facilities are minimized and safety is dramatically increased.

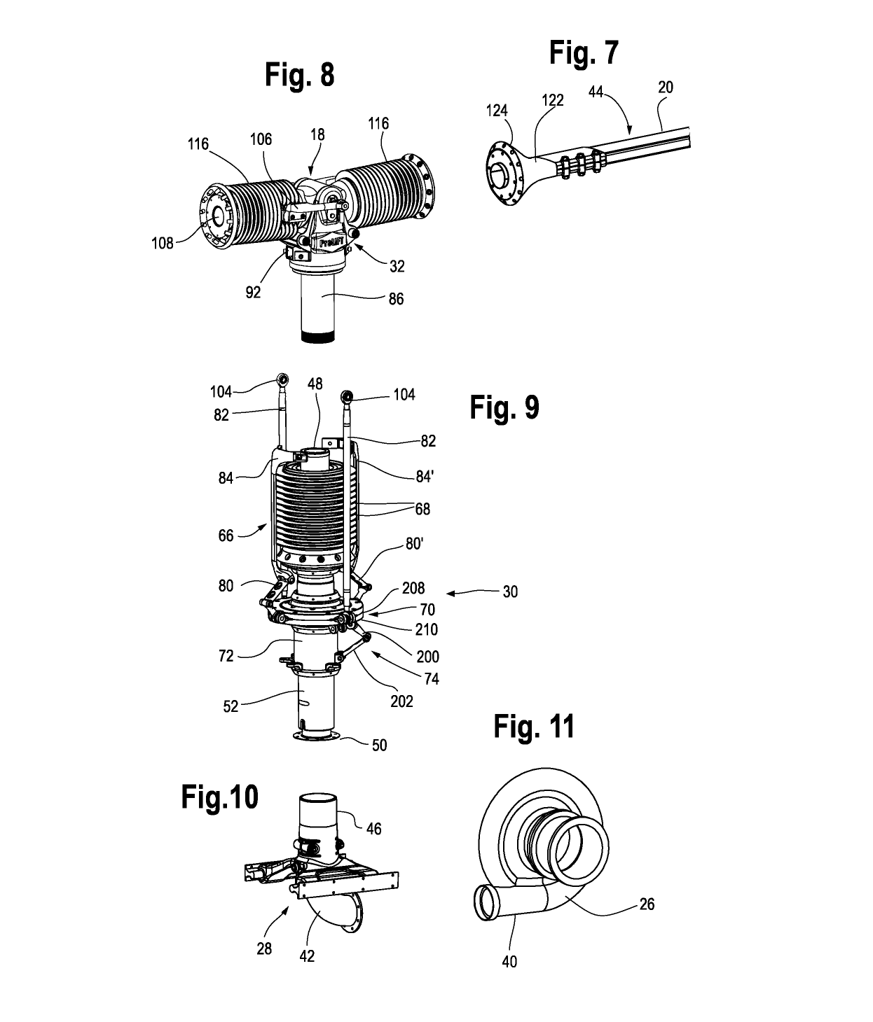

The helicopter 10 shown in FIGS. 1 and 3-6 is operated by a pressure jet propulsion system 34, the parts of which are generally shown in relative exploded perspective view in FIGS. 7-11, and more specifically described below with respect to FIGS. 2 and 12-32. The helicopter illustrated in FIGS. 1 and 2-6 includes the fuselage 16, the frame 12, a housing 36, and a mounted engine (not shown) for powering the centrifugal compressor 26. The engine operates the compressor 26 to create a volume of compressed air for delivery to the rotor blades 20, as briefly mentioned above. In this respect, compressed air generated by the compressor 26 is directed into the mast mount assembly 28 through a duct 40 of the centrifugal compressor 26 to a transition duct 42 of the mast mount assembly 28. This compressed air then travels through the mast assembly 30, the head assembly 32 and a blade assembly 44 for eventual discharge from the blades 20, as described in more detail below.

More specifically with respect to FIGS. 7-11, the mast mount assembly 28 receives compressed airflow generated by the compressor 26 through coupling of the transition duct 42 to the duct 40 of compressor 26. The compressor 26 is solidly mounted to the mast mount assembly 28 and moves in unison with the mast assembly 30.

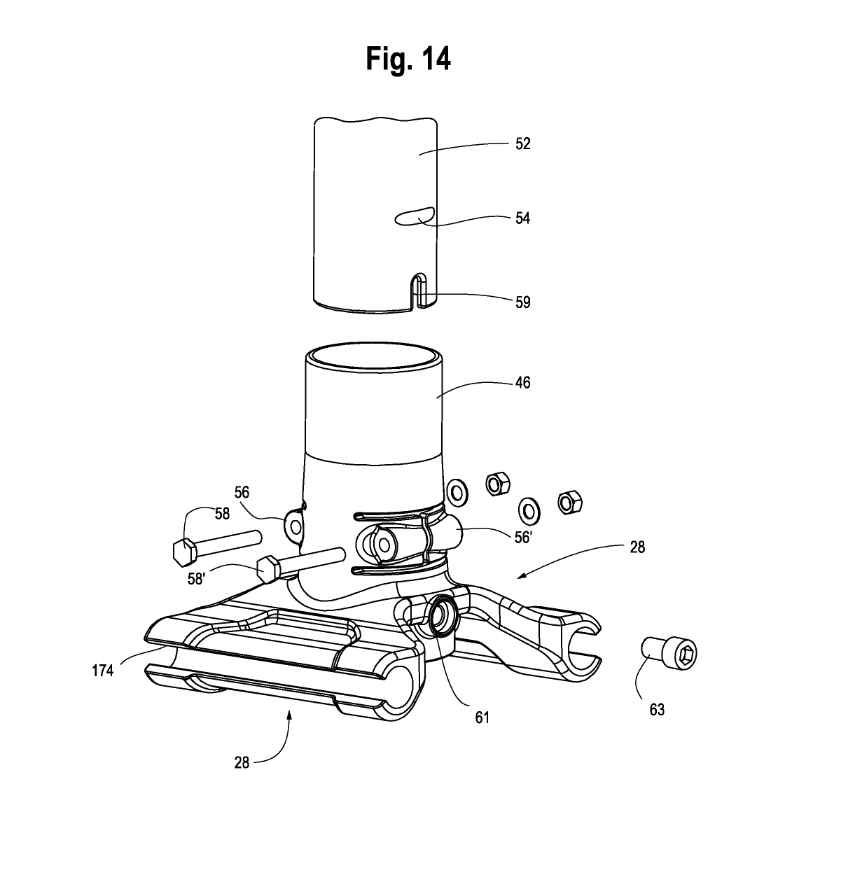

The L-shaped transition duct 42 channels the compressed airflow entering the mast mount assembly 28 upwardly into an upper end 46 thereof for delivery to the mast assembly 30. The mast assembly 30 includes an inner central duct 48 that includes a flanged lower end 50 that couples to the L-shaped transition duct 42. The central duct 48 is positioned concentric within a hollow mast post 52 configured for slip fit engagement with the upper end 46 of the mast mount assembly 28. As more specifically shown in FIG. 14, the mast post 52 includes a pair of longitudinal slots 54 perpendicularly traversing a portion of the generally cylindrical outer housing of the mast post 52. When in slide-fit reception with the upper end 46, the slots 54 substantially align with a pair of bolt clamps 56, 56′ that receive respective bolts 58, 58′. The radial orientation of the mast post 52 is held by locating a vertical slot 59 in the lower end of the mast post 52 with a threaded receptacle 61 in the mast mount assembly 28 and inserting a threaded fastener 63. The vertical constraint of the mast post 52 is made by the bolts 58, 58′ engaging the longitudinal slots 54 in the lower end of the mast post 52. When the bolts 58, 58′ are inserted and tightened, the bolt clamps 56, 56′ provide a compression keyed fit to secure the mast post 52 to the mast mount assembly 28.

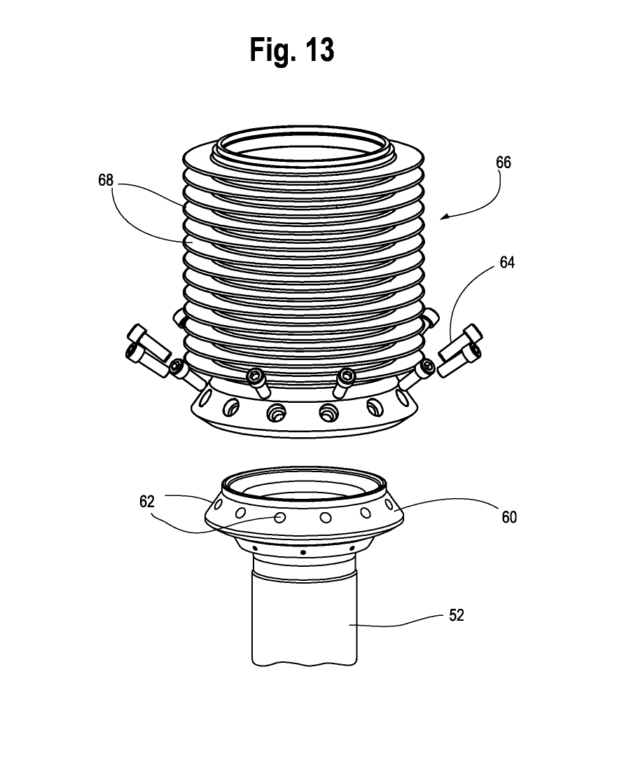

At an upper end thereof, the mast post 52 includes a radially extended surface 60 that includes a plurality of threaded holes 62 configured for threaded reception of respective fasteners 64 designed to attach a non-rotating bearing housing 66 (FIGS. 9, 1 2-1 3 and 27-28) to the mast post 52. As shown in FIG. 13, twelve fasteners 64 attach the bearing housing 66 to the mast post 52 and are designed to carry the full load of the helicopter 10 during operation. The fasteners 64 are safety wired from one another as a means for positively locking the fasteners 64 into the bearing housing 66 and to further prevent the fasteners 64 from loosening due to vibration and other forces during operation of the helicopter 10. Furthermore, the bearing housing 66 includes an array of external fins 68 defining an extended surface heat transfer area. The external fins 68 function as a heat sink to providing automatic cooling of the heated compressed airflow passing through the central duct 48 of the mast assembly 30.

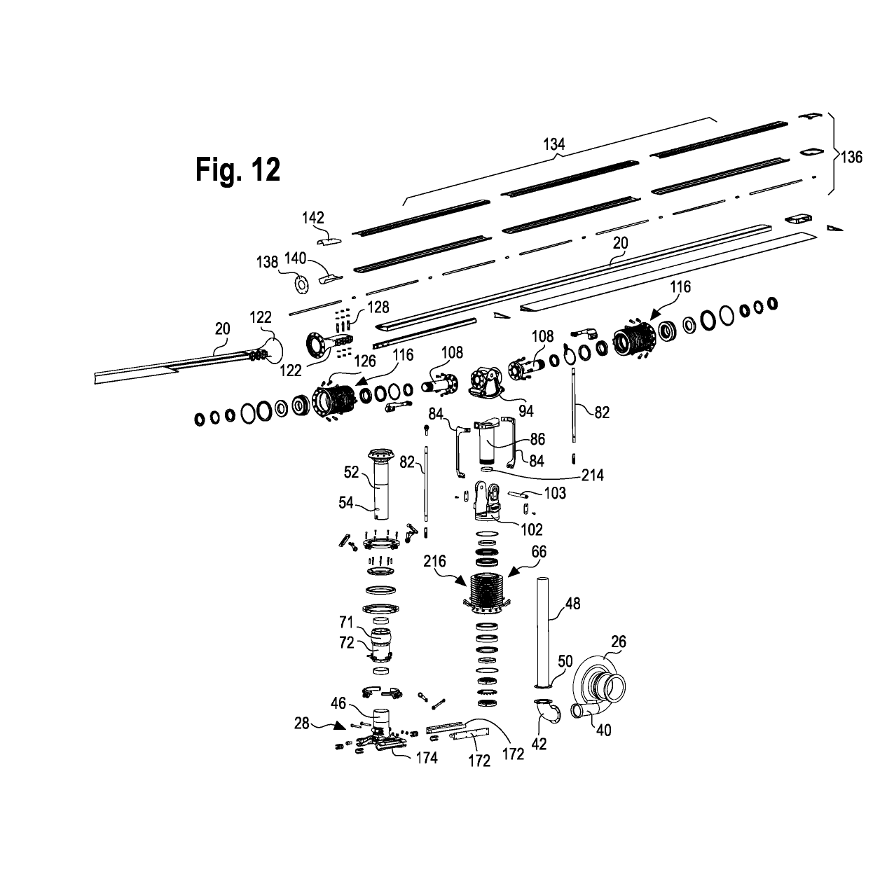

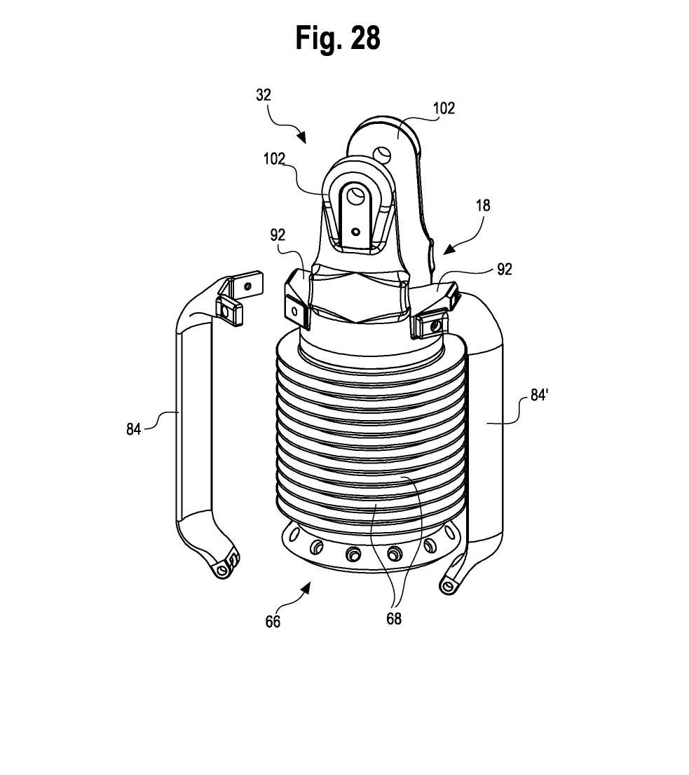

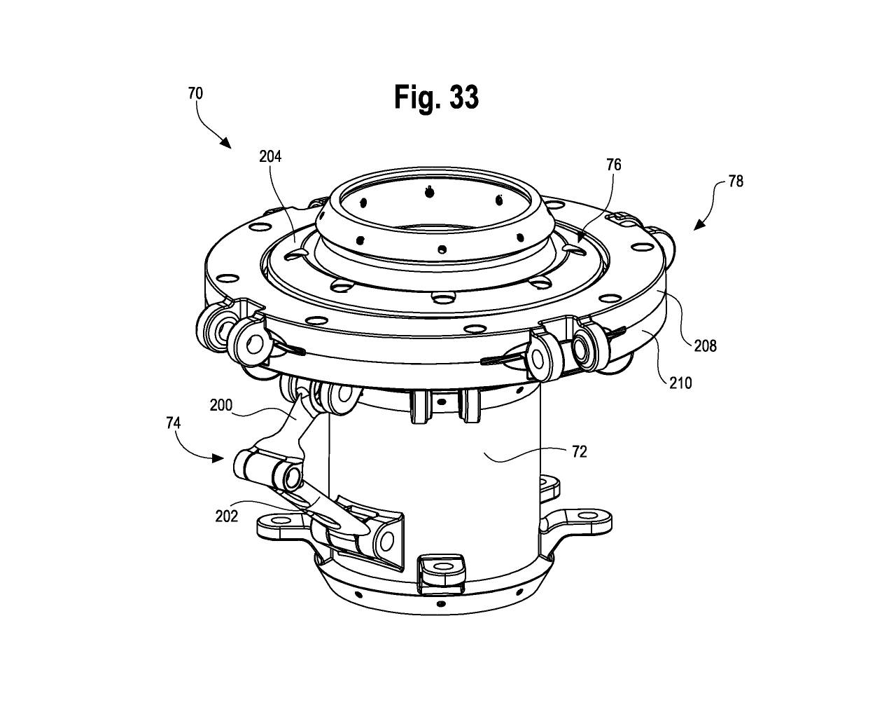

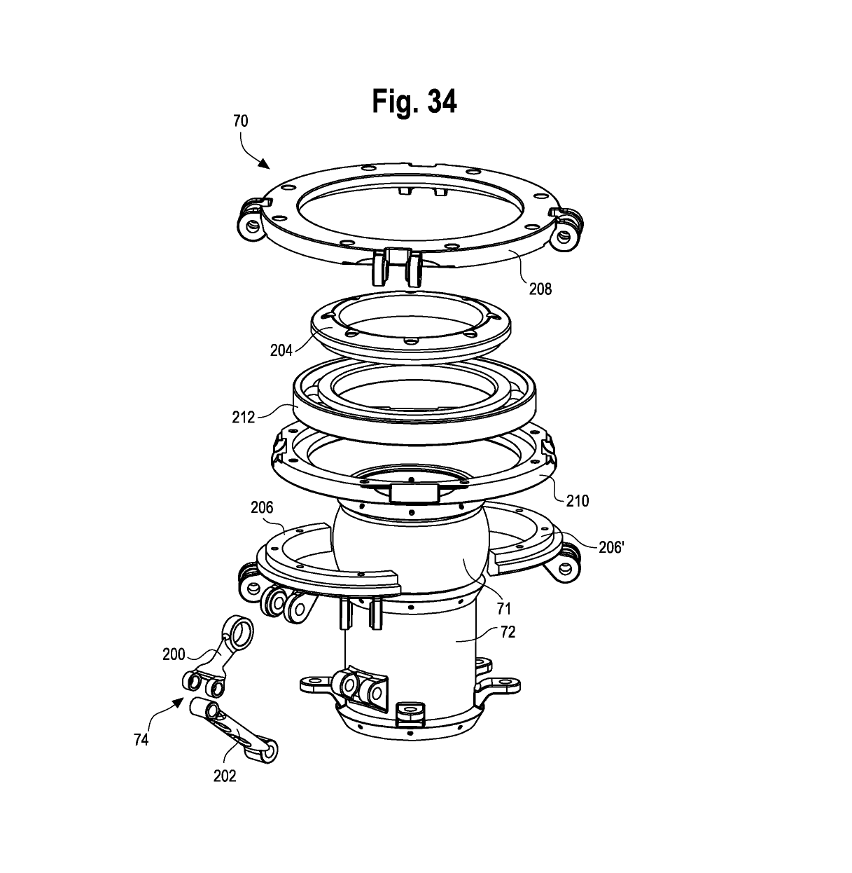

Moreover, the mast assembly 30 further includes a swashplate assembly 70, shown in FIGS. 9 and 33-34, designed to mount concentrically over an upper spherical ball section 71 (best shown in FIGS. 12 and 34) of a sleeve 72. When assembled, the swashplate assembly 70 is free to globally move about the center of the upper spherical ball section 71 of the sleeve 72. The sleeve 72 slides relative to mast post 52 and includes a single lower linkage assembly 74 that includes an upper link 200 and a lower link 202. The two links 200, 202 of the lower linkage assembly 74 limit the radial movement of the swashplate assembly 70 relative to the sleeve 72, while simultaneously allowing full global movement of the swashplate assembly 70 about the spherical ball section 71. The swashplate assembly 70 includes a three piece inner ring assembly 76 that includes an upper inner ring 204 and a two piece lower inner ring 206, 206′ and a two piece outer ring assembly 78 that includes an upper outer ring 208 and a lower outer ring 210, the ring assemblies 76, 78 couple by a radial bearing 212. The inner ring assembly 76 is held radially from rotating by the linkage 74, as shown in FIG. 9 and more specifically in FIGS. 33-34. The outer ring assembly 78 is free to rotate with the rotor hub 18 (FIG. 8) as coupled by a pair of upper linkages 80, 80′ and a pair of airfoil links 84, 84′. The upper linkages 80, 80′ globally attach to the outer ring assembly 78 of the swashplate assembly 70 and pivotally attach to a lower end of a pair of airfoil links 84, 84′ (FIGS. 9, 12 and 28) that attach to the head assembly 32 as generally shown in FIG. 28. The airfoil links 84, 84′ rotate with the rotor blades 20 and function in operation to move or displace cooling air over the fins 68 of the bearing housing 66 as a result of the shape of the airfoil links 84, 84′. The airfoil links 84, 84′ provide much needed cooling when the helicopter 10 is stationary. Importantly, additional cooling air is moved over the fins 68 as the blades 20 rotate faster, and upon movement of the helicopter 10 when flying.

The principle purpose of the swashplate assembly 70 is to control the pitch of the blades 20. The swashplate assembly 70 may be controlled by a “cyclic” (or joystick) that allows the pilot to move the inner ring assembly 76 of the swashplate assembly 70 in a global manner about its center via a linkage (not shown). The outer ring assembly 78 of the swashplate assembly 70 is directly coupled to the rotor hub 18, and more specifically the blade grip bearing housing 116 by the upright posts 82 and the pivot arm 106 (FIGS. 8 and 9). Movement of the “cyclic” (or joystick) changes the angular position of the swashplate assembly 70 in a global and modified horizontal manner. When the swashplate assembly 70 is in an absolute horizontal plane, the pitch of the blades 20 does not change as the rotor hub 18 coupled to the swashplate assembly 70 rotates. Once the swashplate assembly 70 is pitched in any global position from the horizontal plane, the blades 20 continually change pitch as the rotor head 18 rotates. This change in the blade 20 pitch controls the forward, rearward, leftward and rightward movement of the helicopter 10. Likewise, ascending and descending movements of the helicopter 10 are controlled by a “collective” lever connected to the sleeve 72 (FIG. 9.) by a linkage (not shown). Moving the “collective” (not shown) upwardly or downwardly collectively increases or decreases, respectively, the pitch of the blades 20, causing elevation changes with the helicopter 10.

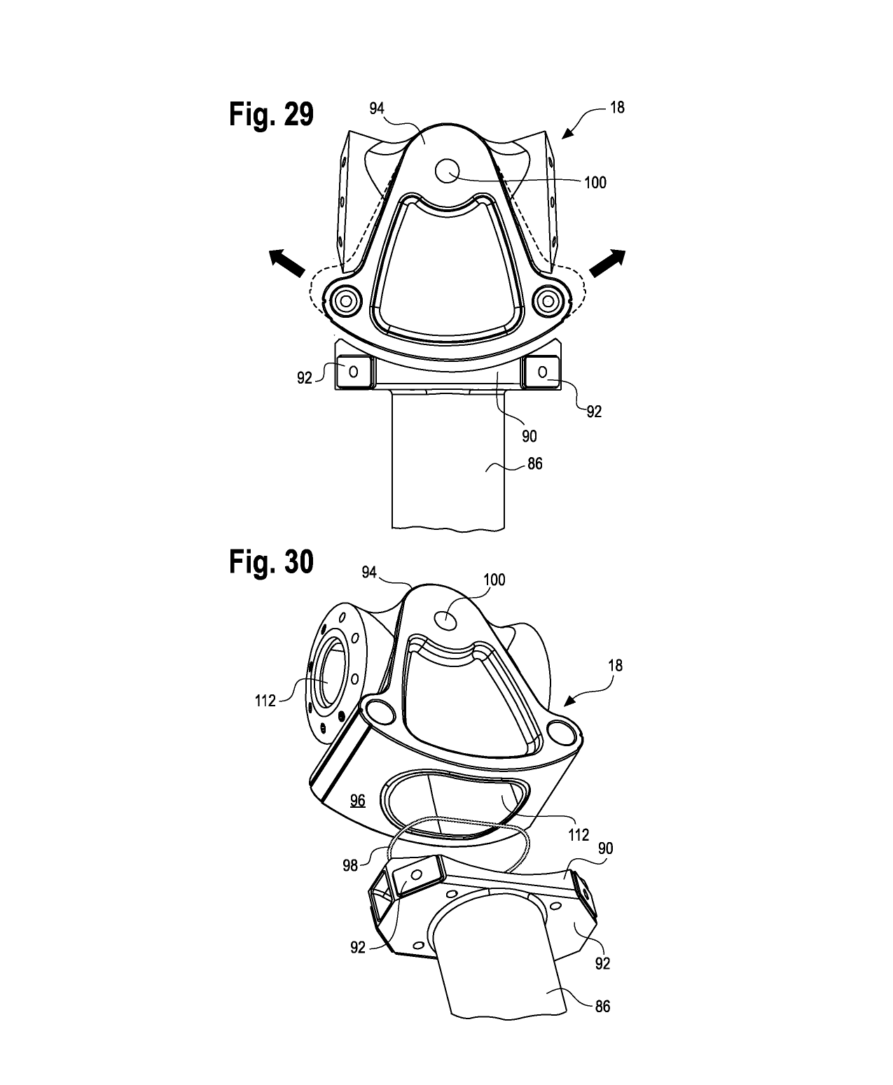

The head assembly 32 generally includes a rotatable cylindrical spindle 86 held radially by a series of bearings 214 and vertically by threaded fasteners 216 within the bearing housing 66 (FIG. 12). Furthermore, the spindle 86 is configured for slide-fit engagement with the central duct 48 to provide a conduit for compressed airflow traveling from the mast assembly 30 to the head assembly 32 for eventual travel out through the blade assembly 44, in accordance with the embodiments described herein and best illustrated in FIGS. 7-9. Importantly, the spindle 86 includes an upper concave arcuate spindle head 90 (FIG. 29) that includes a pair of airfoil couplers 92 generally extending outwardly from the cylindrical spindle 86. The airfoil couplers 92 permit attachment of the upper ends of the airfoil links 84 in the manner generally shown in FIG. 28. Furthermore, a hollow head unit 94 having a reciprocally arcuate surface 96 (FIG. 30) matching the geometry of the concave arcuate spindle head 90 seals thereto by use of an O-ring seal 98. The close fit tolerance between the hollow head unit 94 and the spindle 86 with the O-ring seal 98 (FIG. 30) permits air-tight transmission of heated airflow from the ducting in the spindle 86 to the head assembly 32. The O-ring seal 98 is preferably inserted into a machined groove prior to assembly, which further permits rocking or flapping motion of the hollow head unit 94 relative to the spindle 86 in an airtight manner.

FIG. 29 illustrates the principle behind the blade flapping head motion between the curved or convex surface 96 and the reciprocally formed curved or concave spindle head 90 with the O-ring seal 98 installed there between to provide a seal for compressed air. The two-blade head unit 94 rotates radially as indicated by the directional arrows shown in FIG. 29. The close clearance fit to the spindle 92 provides enhanced precision movement therein. More specifically in this respect, the head unit 94 flaps in an upwardly and downwardly manner, or rocking motion, about an axis 100 (FIGS. 29-30) formed by physically mounting the head unit 94 between a pair of mounting fixtures 102 and a pin 103 (FIG. 1 2). This flapping motion allows the advancing blade(s) 20 to move upwardly and the retreating blade(s) 20 to move downwardly in a natural unrestricted manner during flight. If flapping was not allowed to take place, the helicopter 10 would roll out of control as air speed increases.

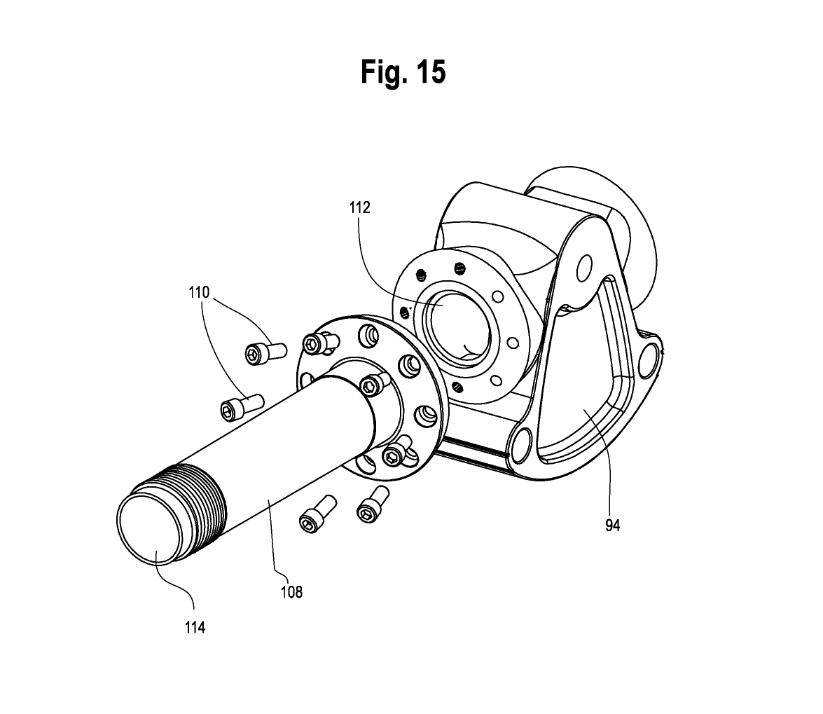

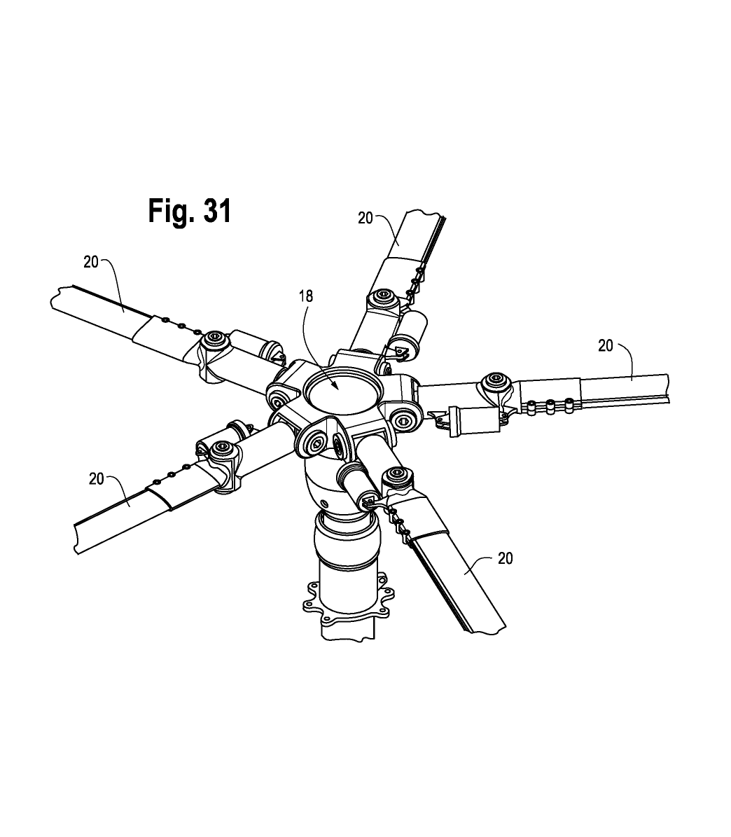

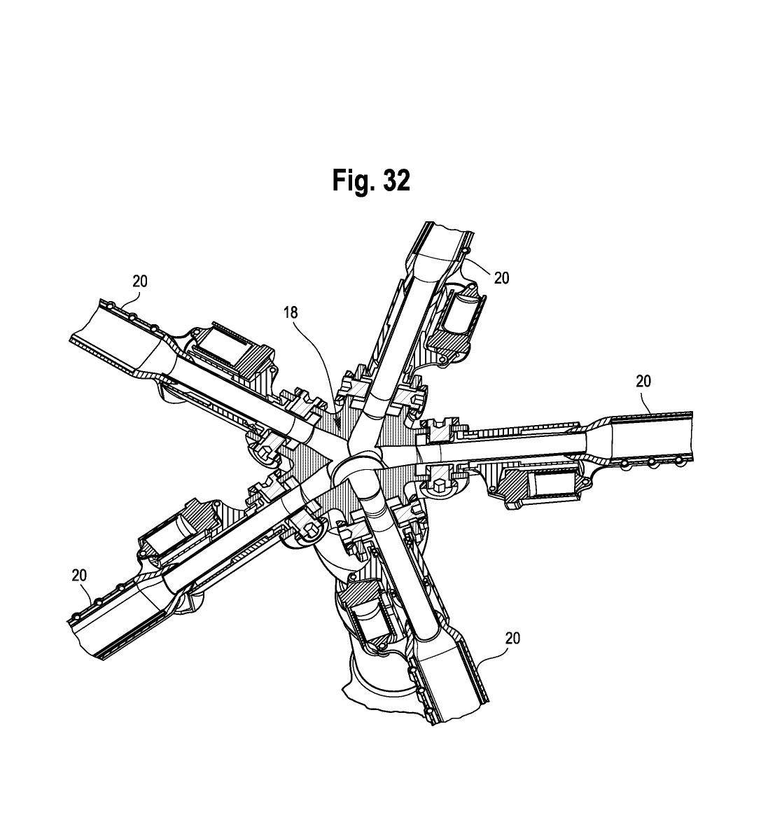

As shown in FIG. 15, the head unit 94 couples to a blade grip spindle 108 by eight radial fasteners 110 that carry the full centrifugal load of the rotating blades 20. These fasteners 110 are also preferably safety wired to one another to prevent loosening during helicopter operation. Compressed air in a hollow passage 112 (FIGS. 15 and 30) of the head unit 94 is diverted to at least a pair of blade grip ducts 114 (one shown in FIG. 15 for purposes of illustration) for travel to the blades 20. The head unit 94 accommodates a number of the rotor blades 20, with FIGS. 29-30 showing a 2-blade head and FIGS. 31-32 showing an alternate 5-blade head. Each outlet port or hollow passage 112 of the head unit 94 is coupled to a respective blade grip spindle 108 (FIG. 15) in accordance with the embodiments disclosed herein.

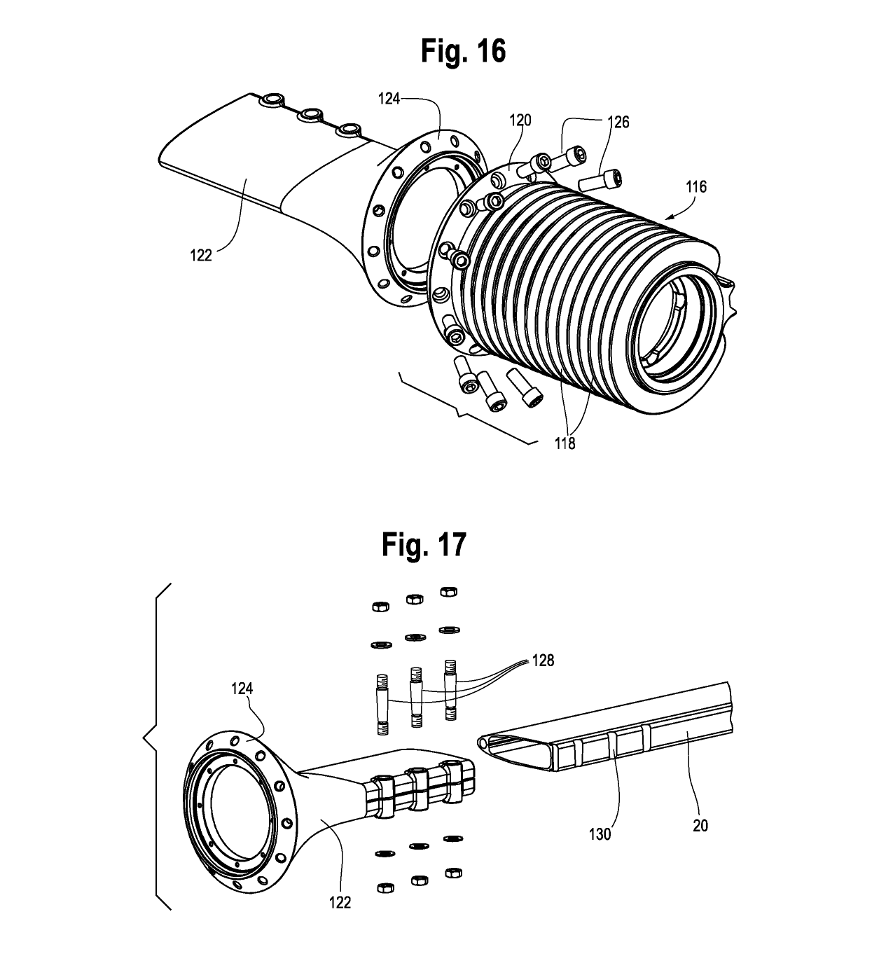

Additionally, each of the blade grip spindles 108 includes a rotatably mounted blade grip bearing housing 116 having a plurality of external fins 118 similar in construction to those fins 68 used in connection with the bearing housing 66. The blade grip bearing housing 116 rotates about the blade grip spindles 108 by a bearing structure (not shown) and provides enhanced heat-sink based cooling of the underlying blade grip duct 114 to provide additional cooling of the heated airflow. Adequate cooling of the heated airflow is important so the blades 20 may be made from a lightweight material such as aluminum without the risking damage thereto as a result of the passage of continually highly heated airflow. The blade grip bearing housing 116 is in turn connected at its radially outermost end 120 to a blade grip unit or assembly 122. As shown best in FIGS. 7 and 16-17, each blade grip unit 122 includes a circular flared end 124 that fits and bolts with one of the blade grip bearing housings 116 at the radially outer end 120 thereof. FIG. 16 illustrates an exploded perspective view of the blade grip bearing housing 116 relative to the blade grip unit 122 as would be assembled together with the use of the generally radially extending fasteners 126. These fasteners 126 also carry the full centrifugal load of the rotating blades 20 and are safety wired from one to another to enhance the safety of the helicopter 10.

FIG. 17 further illustrates the blade grip unit 122 as having a generally flat rectangular section having a size and shape configured for fitting in nested relation with the rotor blade 20. Here, the blade grip unit 122 includes a set of three tapered pins or bolts/screws 128 used to fasten the blade 20 to the blade grip 122. These tapered pins 128 insert through a portion of the blade grip 122 as shown to engage a set of corresponding vertical slots 130 formed in the outer periphery of the blade 20. When tightened, the pins 128 force the blade 20 forward by wedging the blade 20 within the blade grip 122 and locking the three slots 130 of the blade 20 in place.

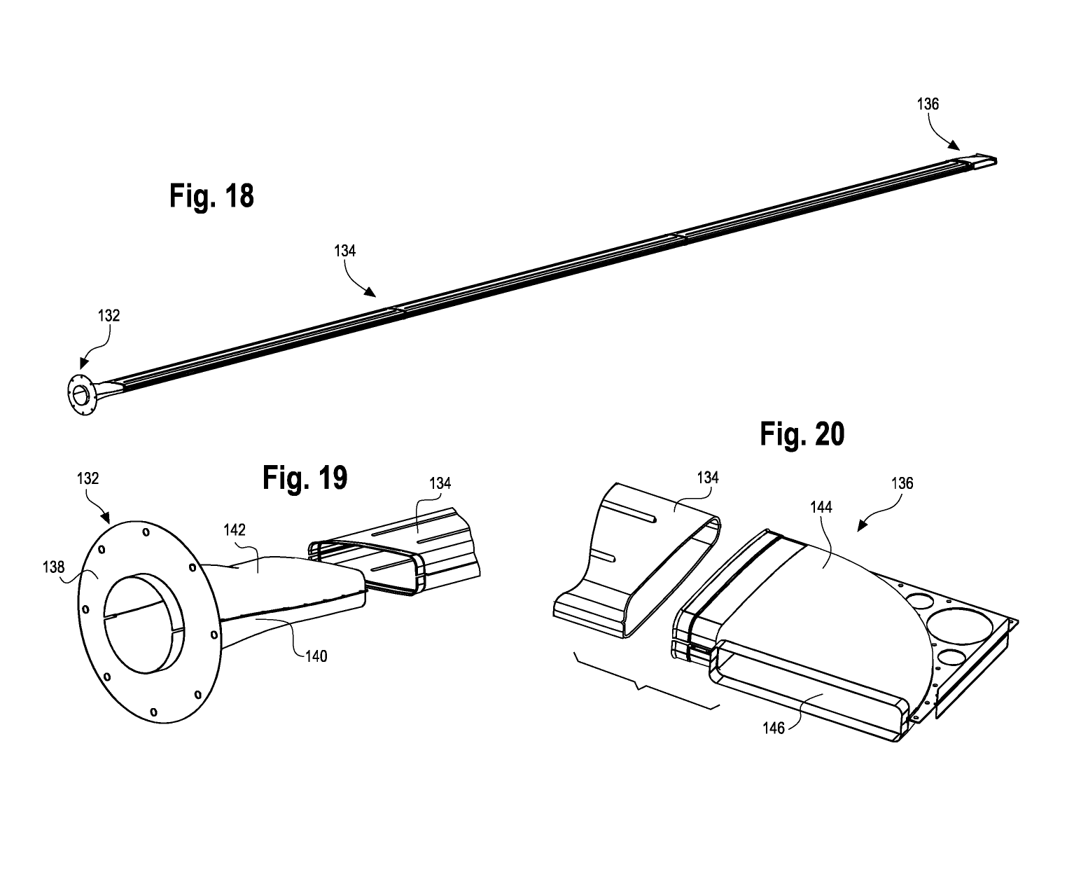

As briefly mentioned above, and in addition to the bearing housings 66, 116 that function in part as a heat sink, the blade assembly 44 includes a ducting system designed to provide further insulation against overheating of the outer blade material and a means for providing efficient heated airflow channeling through the blades 20. In this respect, FIG. 18 is an exemplary embodiment showing such ducting, including a blade grip transition duct 132, a blade duct 134 and a blade tip duct 136. Of particular note, and in general, the ducting system, and in particular the ducts 132, 134, 136, of the pressure jet propulsion system 34 disclosed herein make use of a stainless steel construction to manage heat properties and to ensure rigid and non-melting point movement or flexing of the metal material therein.

More specifically, FIG. 19 illustrates the blade grip transition duct 132 in more detail. Here, the duct 132 is formed from a three piece welded construction that generally includes a flange 138 formed at one end of inter-fitting lower and upper ducting sections 140, 142, respectively. The flange 138 is generally located at the flared end 124 (FIG. 17) and provides a sheltered or insulated conduit between the blade grip unit 122 and the blade grip bearing housing 116. The flange 138 is welded to the lower and upper ducting sections 140, 142, which are likewise welded together as shown in FIG. 19. To this extent, the blade grip transition duct 132 provides an airtight air flow conduit that couples to the blade duct 134.

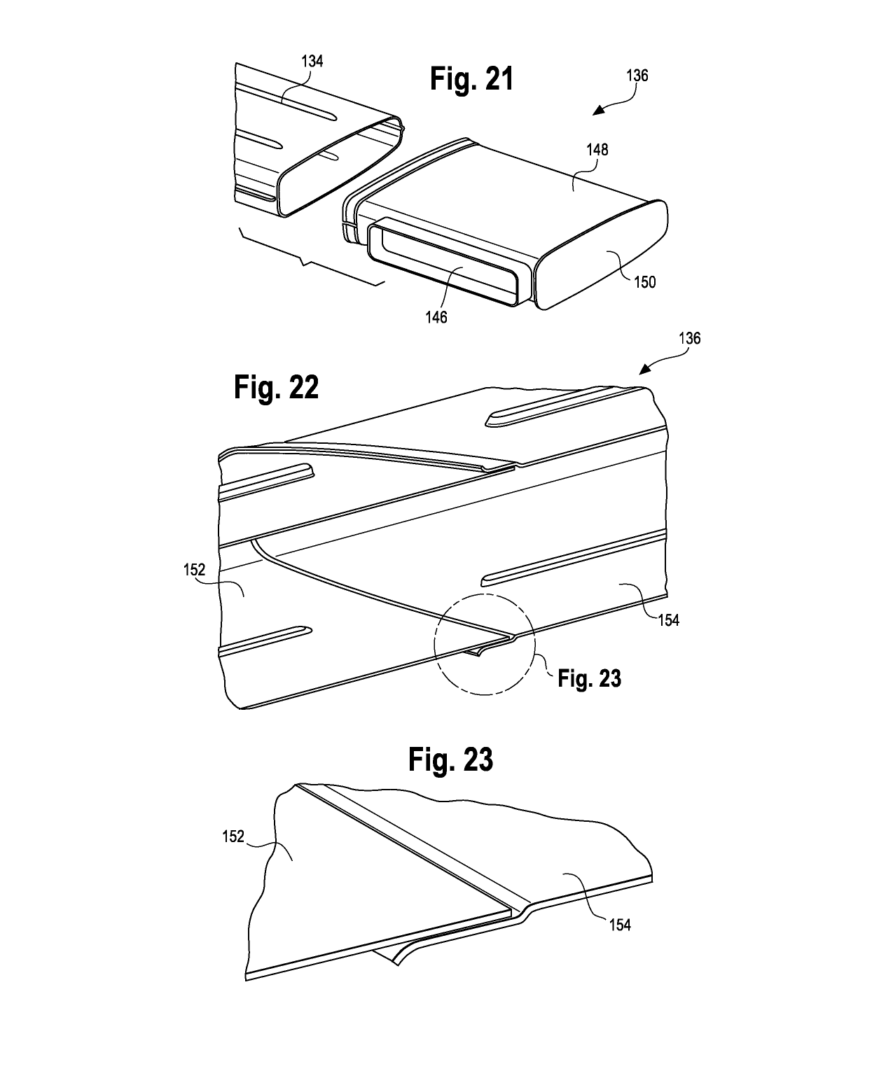

In this respect, FIGS. 19-21 illustrate the blade duct 134 as it couples to both the blade grip transition duct 138 at a proximal side (FIG. 19) and the blade tip duct 136 at the distal or radially outer transition tips of the blades 20 (FIGS. 20-21). More specifically, FIG. 20 illustrates a smoothly curved or sweep outer transition tip 144 having a narrow or slitted rearwardly directed outlet duct port 146 formed therein. In this embodiment, the blade tip duct 136 is generally shaped into an L-shaped curvature to eject heated airflow through the outlet duct port 146 at a generally 90 degree angle relative to the longitudinal length of the blade 20. FIG. 21 illustrates an alternative embodiment wherein the blade tip duct 136 is in the form of a so-called dead head transition tip 148 similarly having the narrow or slitted rearwardly opening outlet duct port 146 formed therein, but at a harsher 90 degree angle without a curvature. In this embodiment, the blade tip duct 136 simply includes a cap 150 at its distal end so that heated airflow is directed out through the outlet duct port 146.

Compressed air is expelled rearwardly at the radially outer tip end of each rotor blade 20 through the slitted outlet duct port 146. The expulsion of compressed air through the narrow outlet duct ports 146 formed in the blade tip duct 136 results in the rotation of the rotor blades 20 without the inherent counter-rotation problems encountered in conventional direct-drive helicopter propulsion systems. The faster the relatively high mass flow of air is pumped and expelled through the outlet duct ports 146, the faster the blades 20 (rotors) will rotate. A typical air compressor, such as compressor 26, includes a centrifugal compressor having a mass flow capacity on the order of 3,000-5,000 cubic feet per minute (cfm). Additionally, icing precautions during flight are effectively eliminated because compressed air temperatures running through the rotor blades 20 are within the range of about 300-550 degrees Fahrenheit offering natural blade deicing.

FIG. 22 shows initial slip-fit mounting exemplary in inter-fitting the various ducting components, such as the ducts 132, 134, 136, whereas FIG. 23 is an enlarged perspective view taken about the box 23 of FIG. 22, further illustrating such slip fit engagement. As shown in FIGS. 22-23, the exit end of a duct section 152 inserts into a flanged inlet end of a duct section 154 having the inlet end of duct section 154 generally bending away from engagement therewith to facilitate slip fit alignment while engaged thereto.

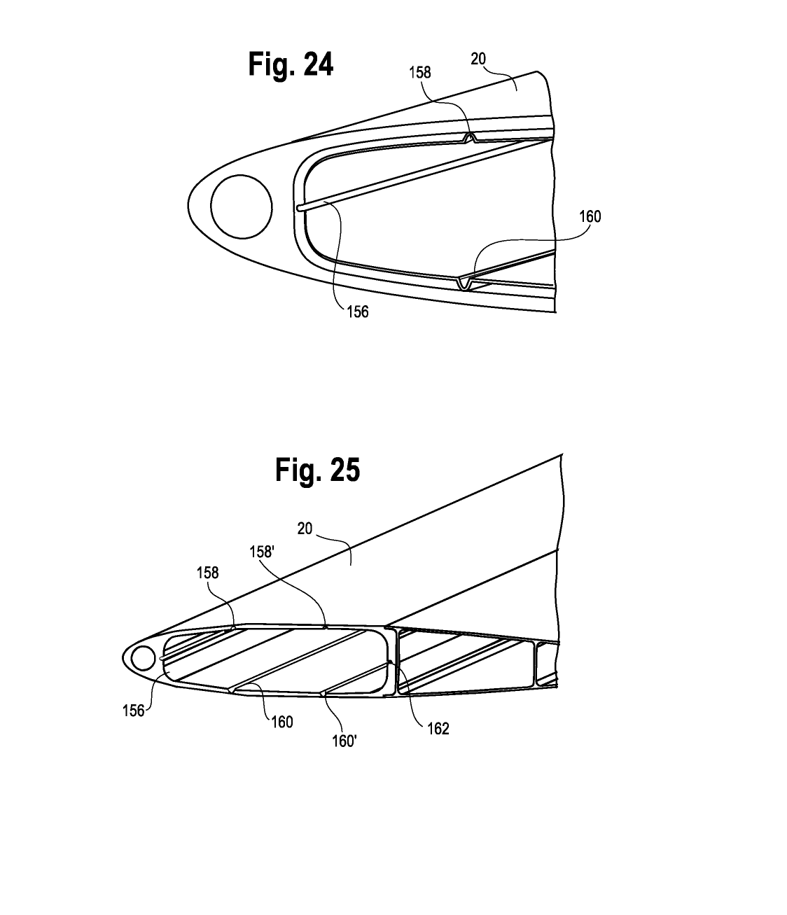

Furthermore, FIGS. 24-25 illustrate preferred constructions for lining the interior of the blades 20 with, for example, the aforementioned blade duct 134. FIG. 24 illustrates an enlarged perspective view of the blade duct 134 including a fore indexing flange 156, a top rib 158 and a bottom rib 160. Moreover, FIGS. 25 illustrates the blade duct 134 disposed within the interior of the blade 20 and including the fore indexing flange 156, a pair of top ribs 158, 158′, a pair of bottom ribs 160, 160′ and an aft indexing flange 162. The flanges 156, 162 and the series of ribs 158, 158′, 160, 160′ bias the blade duct 134 away from direct engagement with the interior of the blade housing 20. This feature controls ballooning of the rotor blade 20 in response to heated compressed airflow therethrough and provides an air cooled buffer between the substantially heated ducting and the blades 20, which may also include a ceramic coated inside surface to provided additional heat shielding.

Accordingly, inclusion of the aforementioned ducting 132, 134, 136 within the interior of the blades 20 and fabricating the blades 20 from metal less prone to material changes as a result of expansion/contraction from heating and cooling, the pressure jet propulsion system 34 tends to have blade assemblies 44 that are heavier than the composite blade assemblies of conventional direct-drive helicopters. In this respect, the rotor system tends to be inherently more stable because of the increased weight of the blade assemblies 44. The heavier rotor blades 20 also provide a higher degree of gyroscopic stability to the helicopter 10, which means less pilot concern over wind gusts and rotor disturbances.

Additionally, helicopters have a specially designated center of gravity or lift point. While a helicopter, such as the helicopter 10 disclosed herein, has a specifically designated center of gravity, it is not always necessary to be in exact balance to fly. Instead, for example, the helicopter 10 can operate within a window of acceptable loading and still be considered within its center of gravity or simply in balance despite not being exactly in balance. But, helicopter controls and range of motion are designed around a specific point of balance. To this end, the center of gravity and balance of a helicopter is determined by the placement of passengers 164 (e.g., as shown in FIGS. 1 and 3-6), the weight and location of baggage and the amount of fuel remaining at any given time. As the number of passengers, baggage and/or fuel changes, so does the center of gravity and balance of the helicopter.

When a conventional helicopter is loaded out of balance, the pilot normally compensates by changing the position of the cyclic or “joy stick”. For example, in a heavy nose condition, the cyclic or joy stick is pulled back to maintain level flight. As the helicopter burns fuel, the cyclic or joy stick must be pulled back even further. The obvious disadvantage here is that the pilot may run out of backward travel of the cyclic to maintain level flight, which can prevent the pilot from maintaining the nose in a safe landing position. Furthermore, the pilot must constantly pull back on the cyclic during flight. This condition requires that the pilot constantly maintain active engagement with the cyclic or else the helicopter will move into an unstable position. In other words, if the pilot takes a hand off the cyclic the helicopter is unable to maintain balance, which is especially dangerous in the event the pilot loses contact with the cyclic or otherwise becomes temporarily or permanently incapacitated.

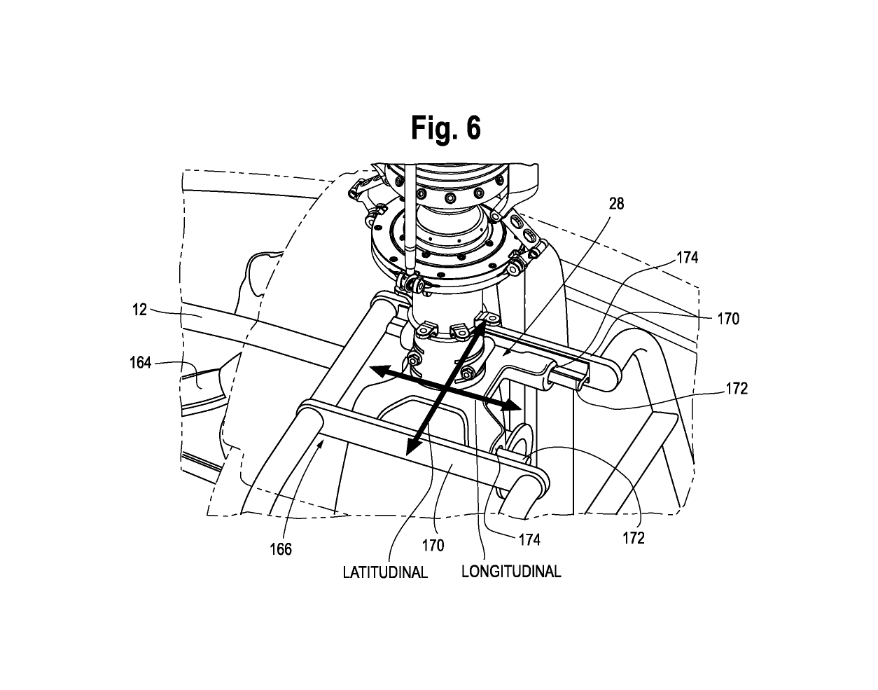

The present pressure jet propulsion system 34 rectifies these deficiencies by providing a mechanism for manually and/or automatically moving the mast mount assembly 28 longitudinally (shown) and/or laterally (in a similar left-to-right track system) in real-time to allow the mast assembly 30 to move over the center of gravity of the helicopter 10 so that the flight controls may be left in a neutral designated position for full range of motion and flight control. In this respect, the mast mount assembly 28 is movably carried by a rail system 166, as shown best in FIG. 6, to permit manual and/or automatic adjustment or trimming of the mast assembly 30. For example, as shown in FIG. 6, the rail system 166 permits longitudinal and latitudinal (with a similar perpendicular rail system) movement of the mast mount assembly 28 along a vertical axis designed to center the mast assembly 30 with respect to the center of gravity of the loaded helicopter 10. More specifically, the rail system 166 includes, in a preferred form, a pair of rearwardly extending frame members 170 each having a linear rail 172 projecting therefrom in an inboard direction to fit into a pair of linear bearings 174 (FIGS. 6 and 14) inserted into the mast mount assembly 28. The linear bearings 174 ride on the linear rails 172 to accommodate fore-aft or longitudinal adjustment of the helicopter center of gravity, whereas latitudinal adjustment of the helicopter center of gravity is accomplished in a similar manner (not shown). Accordingly, longitudinal and latitudinal adjustment or trimming of the vertical axis of the mast assembly 30 is accommodated manually and/or automatically each time the helicopter 10 is loaded, according to the specific weight pattern of loading and the weight distribution of the occupants or the passengers 164. In this respect, load sensors (not shown) in the seats and baggage area, load sensors on the landing gear mounting points, and fuel level sensors provide data feedback for computing the center of gravity and balance point of the helicopter 10 at any given point in pre-flight or during flight. A mast servo drive positioning system (not shown) is controlled by an on board central processing unit (CPU) which gathers and processes weight and fuel data to position the mast assembly 30 in real-time. A manually controlled positioning system may be included to back up the servo drive positioning system.

In operation, trim of the helicopter 10 is manually made by the pilot or automatically achieved by an on board computer by moving the vertical axis of the mast assembly 30 over the specific center of gravity (CG) of the helicopter 10. For explanation purposes, a substantially trimmed helicopter will have its floor substantially horizontal as the helicopter lifts off. If the CG of the helicopter 10 is forward of the mast assembly 30, the helicopter 10 will be nose heavy and hang nose low at lift off. If the CG of the helicopter 10 is aft of the mast assembly 30, the nose will be high at lift off. Likewise, the same holds true in the latitudinal axis. The CG in a helicopter is ever changing based on the number and weight of its pilot, passengers, baggage and fuel. In addition, most helicopters will normally become nose heavy as fuel is burned off in flight. Importantly, because counter-torque does not exist in a pressure jet propulsion driven helicopter, the need for a separate tail rotor and supporting bearings and the like are not required in the helicopter 10 of which uses the pressure jet propulsion system 34, thereby also not requiring constant hands-on control by the pilot with continuous attention to the cyclic (for pitch and roll), collective and throttle controls (for altitude) to maintain proper flight altitude. The need for such constant control is greatly eliminated with the pressure jet propulsion system 34, which offers a more relaxed and comfortable flight.

Moreover, yaw control of the fuselage 16 of the helicopter 10 is controlled by deflecting the exhaust gases emitted from the engine housing 36 in a lateral direction with a tail rudder 176 or the like. When a piston or rotary engine is used as the power source, a portion of the compressed air can be directed through appropriate exhaust ducting 178 (FIG. 4) to the rear tail rudder 176 to control the yaw movement of the helicopter 10. Different types of engines, of course, can be used to power the compressor 26 such as conventional piston-driven or rotary gas-fueled engines, or a turbine engine which can run on diesel, kerosene or jet-A fuels.

Seeing that the helicopter 10 is free of any counter-torque through use of the pressure jet propulsion system 34, directional controls are smooth and positive, coordinated turns using a cyclic control stick and the rudder tail 176 are easy, and the helicopter 10 basically goes exactly where directed. From the perspective of a pilot, less training time is needed compared to a conventional tail rotor helicopter, and the overall skill level required to fly the helicopter 10 is greatly reduced. Accordingly, the pilot has more time to devote to precise and safer flying when counter-torque forces are absent. Thus, pilot reaction time increases in nearly all situations, thereby resulting in a greater degree of safety and control.

Additionally, when making low speed and hover maneuvers close to the ground, conventional helicopters are put into a relatively more dangerous situation because of the generated counter-torque. Significant training and a tremendous amount of concentration is required to maintain control of the flight altitude of a conventional helicopter during landing maneuvers. In the case of the helicopter 10, when the vertical rear tail rudder 176 is deflected, there is no effect on the engine power level or on the air flow delivered to the rotor blades 20. This makes low speed and hovering much simpler and removes another pilot reaction requirement during close to ground operations - the single most critical phase in flying a helicopter. Also, the absence of a tail rotor eliminates inadvertent contact with the ground and other related injuries, such as striking bystanders on the ground.

The inherent massiveness and mechanical integrity of the pressure jet rotor blades 20 is found in no other helicopter 10 of comparable size. Additionally, there is improved capability to jump-take-off with heavy loads. Another desirable feature of the pressure jet rotor principle is the relatively quiet operation as compared to a tail rotor helicopter. That is, a helicopter 10 utilizing the pressure jet propulsion system 34 will not experience the “whooping” sound as the blades rotate over the tail boom.

The pressure jet propulsion system 34 is not only designed for new helicopter models, such as the helicopter 10 shown and described with respect to FIGS. 1 and 3-6, but the system 34 can also be retrofit into existing helicopter designs, such as the helicopter 10′ (an MD600 Series helicopter) shown in FIG. 35. Preferably, the mast mount assembly 28 (FIGS. 10 and 14) includes one or more connectors (not shown) that permit the mast mount assembly 28 to bolt into an existing airframe 300 at the main transmission mounting points already incorporated therein. The mast mount assembly is driven by a driveshaft 302 coupled to an engine 304, such as an Allison C250-C47 808 shp Turbine Engine with FADEC. By attaching the mast mount assembly 28 to the already existing mounting points, the structural integrity of the helicopter 10′ does not change. To this end, the pressure jet propulsion system 34 may operate substantially as described above without extensive disassembly or reconfiguration of the helicopter 10′, thus providing a relatively easy and quick retrofit that attains some of the above-mentioned advantages, such as the desired light weight and greater payload capacity.

Although several embodiments have been described in detail for purposes of illustration, various modifications may be made without departing from the scope and spirit of the invention. Accordingly, the invention is not to be limited.

What is claimed is:

1. A pressure jet propulsion system, comprising:
an air compressor for generating a mass flow of compressed air;
a mast mount assembly in fluid communication with the air compressor for receiving and channeling the mass flow of compressed air;
a positioning system supporting the mast mount assembly and movable on-demand to relocate the mast mount assembly relative to a center of gravity;
at least two blades in fluid communication with the mass flow of compressed air from the movable mast mount assembly; and
an outlet along each of the at least two blades for discharging the mass flow of compressed air at an angle relative to an axis of rotation, wherein angled discharging causes the at least two blades to rotate about the axis of rotation.

2. The system of claim 1, wherein the positioning system comprises a rail system.

3. The system of claim 2, wherein the rail system includes a pair of inwardly extending linear rails that reciprocally engage a pair of linear bearings in a base of the mast mount assembly such that the linear bearings ride on the linear rails to accommodate fore-aft movement.

4. The system of claim 1, wherein the positioning system is movable both longitudinally and laterally.

5. The system of claim 1, including a load sensor monitoring the center of gravity and providing feedback to a controller adjusting the positioning system on-demand.

6. The system of claim 5, including a mast servo drive operated by the controller for relocating the mast mount assembly.

7. The system of claim 1, wherein the air compressor comprises an engine-driven air compressor.

8. The system of claim 1, wherein the mass flow of compressed air comprises a 3,000 to 5,000 cubic feet per minute (cfm) rate.

9. The system of claim 1, wherein the mass flow of compressed air comprises a temperature between 300 and 500 degrees Fahrenheit.

10. The system of claim 1, including a heat sink coupled in line with the mast mount assembly.

11. The system of claim 10, including a pair of airfoil links at least partially rotatably surrounding the heat sink, the pair of airfoil links each having a geometry for directing air over the heat sink when rotating.

12. The system of claim 10, wherein the heat sink comprises a plurality of fins.

13. The system of claim 1, including a tail rudder for deflecting exhaust gasses emitted by the air compressor.

14. The system of claim 1, wherein the mast mount assembly includes a partially flexible duct.

15. A pressure jet propulsion system, comprising:
an air compressor for generating a mass flow of compressed air;
a mast mount assembly in fluid communication with the air compressor for receiving and channeling the mass flow of compressed air;
a rotor hub fluidly coupled with the mass flow of compressed air from the mast mount assembly and fluidly coupled to at least two blades extending therefrom, the rotor hub pivotable on-demand to upwardly or downwardly reposition the at least two blades; and
an outlet along each of the at least two blades for discharging the mass flow of compressed air at an angle relative to an axis of rotation, wherein angled discharging causes the at least two blades to rotate about the axis of rotation.

16. The system of claim 15, wherein the rotor hub includes a hollow rotor head and a spindle, the spindle being fluidly coupled to a top portion of the mast mount assembly.

17. The system of claim 16, wherein the rotor head includes an arcuate surface pivotable relative to a reciprocally concave surface of the spindle.

18. The system of claim 17, including an O-ring sealing the arcuate surface of the rotor head with the concave surface of the spindle.

19. The system of claim 18, including a groove in the concave surface of the spindle for housing the O-ring, thereby permitting the rotor head to pivot hermetically relative to the spindle.

20. The system of claim 15, wherein the rotor hub includes a coupler for rotatable mounting to an airfoil link.

21. The system of claim 15, wherein the rotor hub is pivotally coupled to a mounting fixture with a pin.

22. The system of claim 15, wherein pivotable movement of the rotor hub advances the at least two blades upwardly or recedes the at least two blades downwardly.

23. The system of claim 15, including at least two blade grip spindles respectively coupling the rotor hub to the at least two blades.

24. The system of claim 23, including at least two blade grip bearing housings respectively rotatably mounted relative to the at least two blade grip spindles, the at least two blade grip bearing housings including a heat sink cooled by airflow during blade rotation.

25. The system of claim 23, wherein the at least two blade grip spindles include a circular flared end coupled to the rotor hub and a flat generally rectangular end for respective nested reception with the at least two blades.

26. The system of claim 15, including a collective coupled to the rotor hub, for increasing and decreasing elevation of the blades.

27. A pressure jet population system, comprising:
an air compressor for generating a mass flow of compressed air;
a mast mount assembly in fluid communication with the air compressor for receiving and channeling the mass flow of compressed air;
a swashplate assembly mounted concentrically over a spherical ball section of a sleeve slidably mounted relative to the mast mount assembly, the swashplate assembly including an upright post pivotally coupled to a rotor head having at least two blades extending therefrom and in fluid communication with the mass flow of compressed air from the mast mount assembly; and
an outlet along each of the at least two blades for discharging the mass flow of compressed air at an angle relative to an axis of rotation, wherein angled discharging causes the at least two blades to rotate about the axis of rotation.

28. The system of claim 27, wherein the swashplate assembly moves globally about a center of the spherical ball section.

29. The system of claim 28, wherein the swashplate assembly modifies the global horizontal position of the at least two blades relative to a zero plane to change the pitch of the at least two blades in a forward, rearward, leftward or rightward manner by way of global movement about the spherical ball section.

30. The system of claim 27, including a linkage assembly limiting radial movement of the swashplate assembly relative to the sleeve.

31. The system of claim 27, wherein the sleeve slides relative to the mast mount assembly.

32. The system of claim 27, wherein the swashplate assembly further includes a three piece inner ring assembly comprising an upper inner ring and a two piece lower inner ring and a two piece outer ring assembly comprising an upper outer ring and a lower outer ring.

33. The system of claim 32, wherein the three piece inner ring assembly and the two piece outer ring assembly couple about a radial bearing such that the inner ring assembly is stationary and the outer ring assembly is free to rotate about the radial bearing.

34. The system of claim 27, wherein the upright post comprises a pair of upright posts pivotally coupled to a pivot arm extending from a blade grip bearing housing.

35. The system of claim 27, including a pair of airfoil links coupled with the swashplate assembly and the rotor head, wherein the airfoil links rotate with the rotor head about a heat sink.

36. The system of claim 34, wherein the airfoil links include a geometry to direct air over the heat sink comprising a series of cooling fins extending away from the mast mount assembly.

37. A pressure jet propulsion system, comprising
an air compressor for generating a mass flow of compressed air;
a mast mount assembly in fluid communication with the air compressor for receiving and channeling the mass flow of compressed air;
at least two blades each having a hollow interior with a duct therein in fluid communication with the mass flow of compressed air from the mast mount assembly, the ducts each including a pair of indexing flanges offsetting the duct from the hollow interior of each blade to form a thermal gap therebetween; and
an outlet along each of the at least two blades for discharging the mass flow of compressed air at an angle relative to an axis of rotation, wherein angled discharging causes the at least two blades to rotate about the axis of rotation.

38. The system of claim 37, wherein the pair of indexing flanges comprise a fore and aft flange or a top and bottom rib.

39. The system of claim 37, wherein longitudinal surfaces of the duct expand and contract about the indexing flanges and within the thermal gap in response to thermal changes.

40. The system of claim 37, including at least a pair of blade grip transition ducts respectively coupling the mass flow of compressed air from the mast mount assembly to each of the at least two blades.

41. The system of claim 37, wherein the ducts include a tip comprising a sweep duct tip or a dead head transition tip.

42. The system of claim 41, wherein the sweep duct tip comprises an L-shaped curve to discharge the mass flow of compressed air at a 90 degree angle relative to a longitudinal length of the blade.

43. The system of claim 37, wherein the duct includes multiple inter-fitting duct sections assembled by slip fit engagement.

44. The system of claim 37, wherein rotational speed of each of the at least two blades is a function of the speed of the mass flow of compressed air discharging from each of the outlets, wherein increasing the mass flow of compressed air out through each outlet increases rotational speed of the at least two blades and decreasing the mass flow of compressed air out through each outlet decreases the rotational speed of the at least two blades.

45. The system of claim 37, wherein each of the at least two blades comprise aluminum, titanium, or a composite material and the duct comprises stainless steel.
